(19) United States
(12) Patent Application Publication
(10) Pub. No.: US 2008/0115881 A1
(43) Pub. Date: May 22, 2008

(54) Process for heat-pressing tape on plastic carrier for chip

(75) Inventors: Chih-Yung Lin, Taichung City (TW); Po-Yu Chiang, Taichung City (TW)

Correspondence Address: HAROON CHOHAN, 22 MEAD STREET, HEMPSTEAD, NY, 11550, US

(73) Assignee: Speck Co., Ltd.

(21) Appl. No.: 11/985,497

(22) Filed: Nov. 15, 2007

(30) Foreign Application Priority Data
Nov. 21, 2006 (TW) 095142977

(51) Int. Cl. B32B 37/02; B29C 65/02; C09J 5/06

(52) U.S. Cl. 156/256; 156/321

(57) ABSTRACT

A process for heat-pressing a tape on a plastic carrier for a chip primarily comprises heating the plastic carrier to a predetermined temperature ranging from about 60 degrees centigrade to about 150 degrees centigrade so that an adhesive provided on the tape for adhering to the plastic carrier is melted such that the adhesive is in an optimum melted state and provides preferable adhesion force.

### BACKGROUND OF THE INVENTION

1. Technical Field

The present invention relates to technologies for adhering chips on plastic carriers and, more particularly, to a preparation for bonding a single tape on a plastic carrier.

2. Description of Related Art

In a conventional process for adhering a chip to a plastic carrier, the plastic carrier formed by an injection method and a single tape properly cut are to be prepared. Then a release liner on one side of the single tape is manually removed so that the single tape can be adhered to the carrier. Afterward, another release liner on the other side of the single tape is also removed so that the chip can be attached to the tape and thereby a combination between the chip and the plastic carrier is accomplished.

In addition to limited output, labor as well as time consumption, and high costs, the foresaid manual adhesion process further has the problem relating to defective products owing to improper tape or chip bonding.

Hence, some efforts have been done to remedy the problems of the conventional manual adhering process. For example, in the disclosure of Taiwan Patent 1224050, an automatic process is provided. The process primarily comprises preparation, cutting, heat-pressing, and cold-pressing. Herein, the procedure of heat-pressing will be further discussed.

The purpose of heat-pressing is to heat-press and thus adhere a tape on a plastic carrier. For diverse tapes, a preferable temperature for giving an optimum melted state and a desirable adhesion force thereof is ranging from about 60 degrees centigrade to about 150 degrees centigrade. In the prior process, a ram preheated to the aforementioned temperature is employed to press the tape onto the carrier so as to make the adhesive on the tape adhere to the plastic carrier. However, such approach still has the following problems.

First, when the heated ram presses on the tape, heat energy is indirectly transferred to the adhesive through a release liner and the tape positioned thereabove. Thus, such indirect heating causes an inferior melted state of the lower adhesive.

Further, when the heat ram presses on the tape, the heat directly acts on the release liner at the upper surface of the tape. Thus, an undue heat may cause the release liner deformed and render the adhesive on the tape to be melted thereby resulting in melt flow. As a result, the defective rate of products is increased.

Besides, when the indirectly heated adhesive contacts the plastic carrier of the atmospheric temperature, the temperature of the adhesive is lowered beyond the melting point of the adhesive. Consequently, the adhesive may not be properly melted, and file to cover the whole adhesive area, thereby resulting in depressed adhesion force.

One solution for the problems mentioned above is to heat the ram to a temperature higher than the melt point of the adhesive. However, this may cause additional problems because denaturation and broken crystals may thus happen to the adhesive and depress the adhesion force thereof. Therefore, such solution fails to improve the adhesion force of the tape.

As mentioned above, undue heat may render melt flow of the adhesive, and when such melt flow undesirably smears other areas on the carrier, the product becomes defective.

Moreover, such melt flow of the adhesive signifies the adhesive staying at the adhering surface is insufficient and this consequently causes inferior adhesion force of the type.

Some other prior arts have tried to remedy the depressed adhesion force of the type by extending the duration where the heated ram contacts the tape. However, these prior arts vainly consume processing time and none of them provides significant improvement on the adhesion of the type.

FIGS. 2 and 3 provide an example of a tape 1 imperfectly attached to a plastic carrier 2. In FIG. 2, a region enclosed by a dotted line covers an interval 3 between the tape 1 and the carrier 2 caused by air that intruded because there is no sufficient adhesive at the bottom of the tape 1. It can be seen more clearly in FIG. 3 that the interval 3 significantly reduces the adhesive area between the tape 1 and the carrier 2.

### SUMMARY OF THE INVENTION

In view of these circumstances, the present invention provides a solution for inferior adhesion in the process for heat-pressing a tape on a plastic carrier.

The process of the present invention comprises:

preparing a plastic carrier and a single tape matching the plastic carrier, wherein a release liner is provided on an upper surface of the single tape while an adhesive is applied on an lower surface of the single tape;

heating the plastic carrier to a temperature where the adhesive is melt and an adhesion force of the adhesive is kept as intact; and

giving a pressure to the upper surface of the single tape so as to make the adhesive at the lower surface of the single tape contact the plastic carrier.

The process of the present invention has the following advantages.

First, the step of heating the plastic carrier makes the adhesive at the lower surface of the single tape present an optimum melted state. A preferable range of the heating temperature is from about 60 degrees centigrade to about 150 degrees centigrade. When contacting the plastic carrier, the adhesive of the tape is directly heated and melted so as to achieve the optimum melted state.

Second, as the adhesive is directly heated and evenly melted, when a ram gives the pressure on the tape, the adhesive can be evenly distributed to the whole adhesive area, so that the tape can firmly adhered to the plastic carrier.

Third, the step of heating the plastic carrier is facile and the heating temperature is controllable.

Fourth, since the adhesive of the tape is properly heated by the plastic carrier, integrity of the crystals of the adhesive can be protected and therefore the inherent adhesion force of the adhesive can be ensured so that the tape can be firmly adhered to the plastic carrier.

Fifth, when being properly heated by the plastic carrier, the adhesive of the tape is melted evenly so as to prevent the problem that melt flowing adhesive smears other areas than the adhesive area.

At last, since the tape is free from the problem of melt flowing, the adhesive area contains a sufficient amount of adhesive, so that the tape is ensured with desirable adhesion force.

Upon the above advantages, the process of the present invention contributes to enhanced yield rate of products.

Furthermore, the disclosed process implementing the heated plastic carrier to heat the tape and leaves the ram under the atmospheric temperature. Therefore, when the ram presses upon the release liner at the upper surface of the tape, the liner is secured from deformation and the adhesive at the upper surface of the tape is not going to be melted. Therefore, the yield rate of products can be improved.

### BRIEF DESCRIPTION OF THE DRAWINGS

The invention as well as a preferred mode of use, further objectives and advantages thereof, will best be understood by reference to the following detailed description of an illustrative embodiment when read in conjunction with the accompanying drawings, wherein:

FIG. 1 is a flowchart of a conventional process for manually bonding a single tape on a plastic carrier;

FIG. 2 is a perspective view of a product of another conventional process;

FIG. 3 is a cross sectional view of the product of FIG. 2;

FIG. 4 is a flowchart of a process for bonding a single tape on a plastic carrier according to the present invention;

FIG. 5 is a schematic drawing illustrating apparatuses for bonding the single tape on the plastic carrier according to the present invention;

FIG. 6 is another schematic drawing illustrating operation of the apparatuses for bonding the single tape on the plastic carrier according to the present invention;

FIG. 7 is a perspective view of a product of the process of the present invention;

FIG. 8 is a cross sectional view of the product of FIG. 7;

FIG. 9 is a schematic drawing illustrating apparatuses for heat-pressing a tape on plastic carriers according to the present invention; and

FIG. 10 is another schematic drawing illustrating operation of the apparatuses for heat-pressing the tape on the plastic carriers according to the present invention.

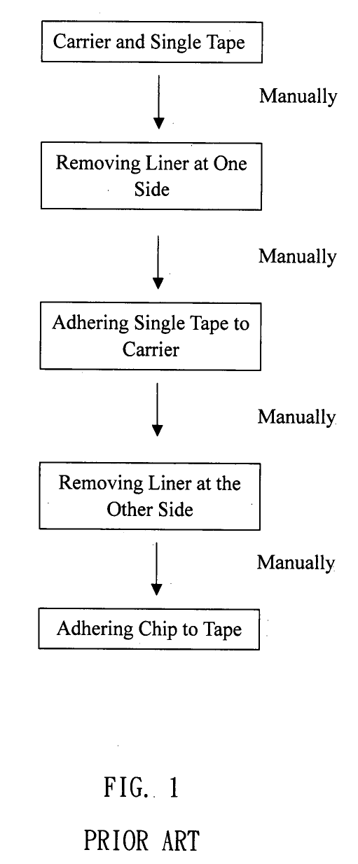

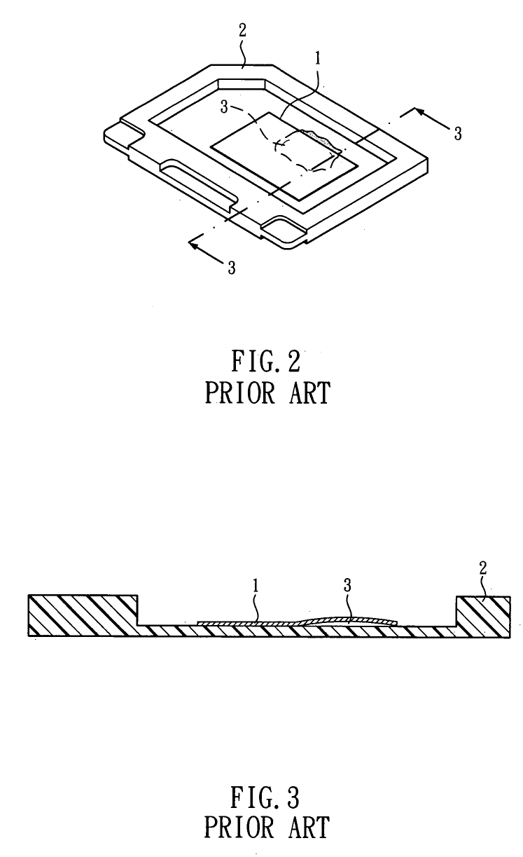

### DETAILED DESCRIPTION OF THE PREFERRED EMBODIMENT

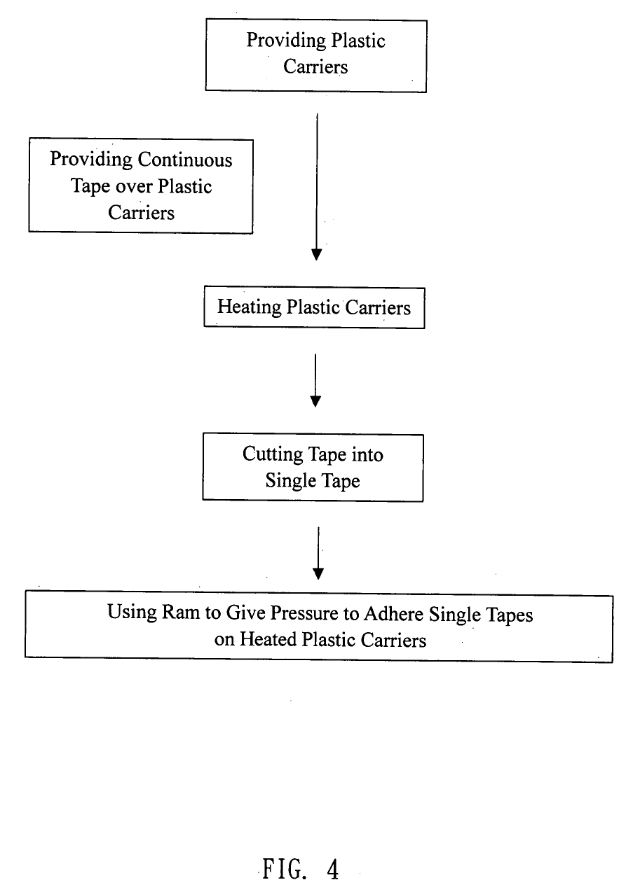

Referring to FIG. 4, a process for heat-pressing a tape on plastic carriers provided by the present invention comprises:

a) successively conveying a plurality of plastic carriers and positioning at least one of the plastic carriers at a predetermined position;

b) passing a tape in a form of a strip over the plastic carriers, wherein the tape comprises a film, an upper adhesive layer provided at an upper surface of the film and covered by a release liner, and a lower adhesive layer provided at a lower surface of the film;

c) heating the plastic carriers to a temperature where the lower adhesive layer is melt to present preferable melted state and adhesion force, wherein the temperature is preferably ranging from about 60 degrees centigrade to about 150 degrees centigrade and the present step can be conducted when the plastic carriers are conveyed or the present step can be conducted when one of the plastic carriers arrives the predetermined position;

d) cutting the tape at a position aligned to the plastic carrier at the predetermined position into a rectangular single tape; and

e) using a ram to press the single tape at an upper surface thereof so that the single tape is separated from the tape and then the lower adhesive layer at the lower surface of the single tape comes into contact with the plastic carrier, which has been heated to the predetermined temperature, so as to make the lower adhesive layer melted by the heat of the plastic carrier and evenly distribute between the film and the plastic carrier.

After the above Step e, the plastic carrier that has been adhered by the single tape is cooled, in the atmospheric temperature.

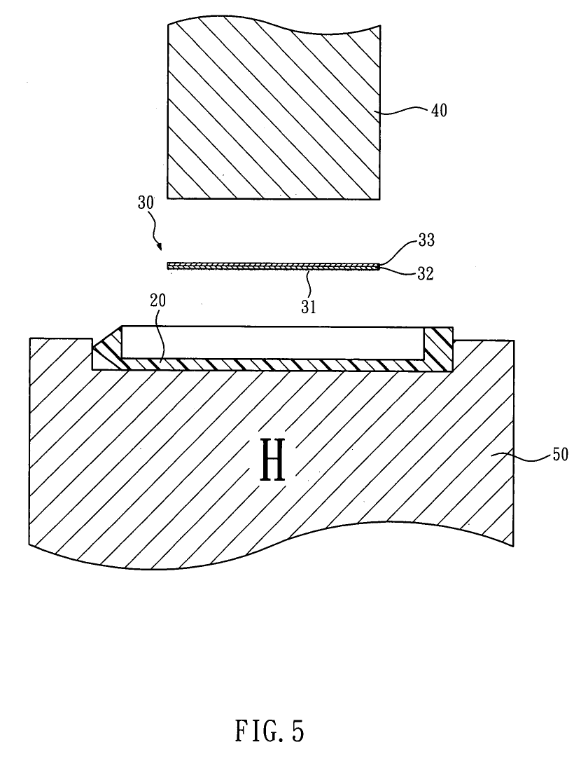

FIG. 5 illustrates apparatuses for bonding the single tape 30 on the plastic carrier 20 according to the present invention. Therein, a plastic carrier 20, a single tape 30 and a ram 40 are provided. The single tape 30 comprises a film 32 having a lower adhesive layer 31 at a lower surface thereof and an upper adhesive layer (not shown) at an upper surface thereof and covered by a release liner 33. The plastic carrier 20 is heated by a heater 50 to a predetermined temperature where the lower adhesive layer 31 at the lower surface of the single tape 30 is melt to present preferable melted state and adhesion force. A preferable range of the heating temperature is from about 60 degrees centigrade to about 150 degrees centigrade.

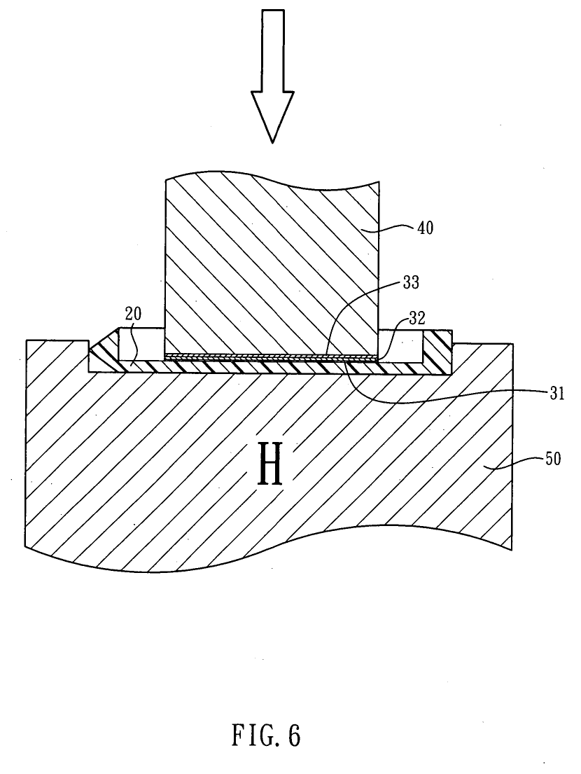

In FIG. 6, the ram 40 presses the single tape 30 thereabove so as to make the lower adhesive layer 31 at the lower surface thereof come into contact with the plastic carrier 20 that has been heated to the predetermined temperature.

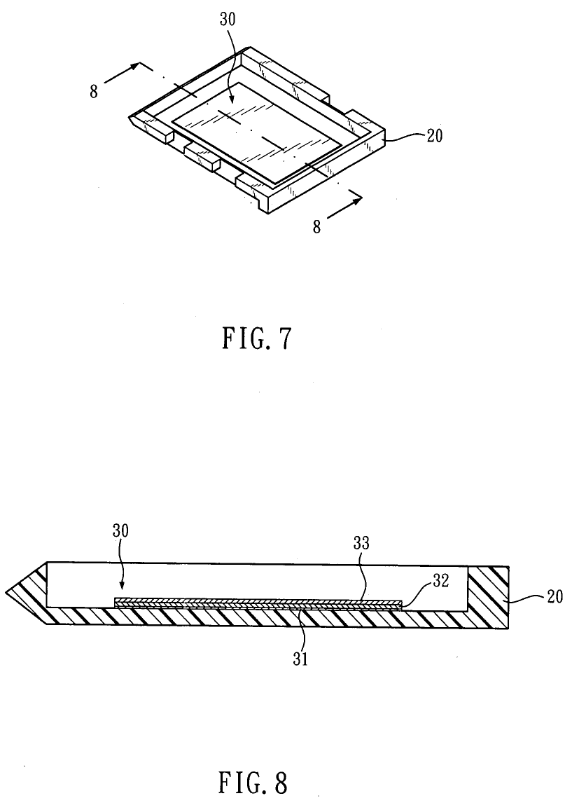

At this time, since the plastic carrier 20 has been heated to the predetermined temperature, when the lower adhesive layer 31 at the lower surface of the single tape 30 contacts the plastic carrier 20, the lower adhesive layer 31 is directly melted by the heat from the plastic carrier 20 so as to achieve a proper and even melted state so that when the melted lower adhesive layer 31 receives the pressure from the ram 40, the adhesive can evenly distributed between the film 32 and the plastic carrier 20. FIGS. 7 and 8 provide the perspective view and cross sectional view of the single tape 30 evenly attached to the plastic carrier 20. In FIG. 7, it can be seen that that single tape 30 is entirely attached to the plastic carrier 20 without any interval therebetween. FIG. 8 more clearly presents that when there is no interval between the plastic carrier 20 and the single tape 30, the plastic carrier 20 and the single tape 30 are combined with the sufficient adhesive area. In other words, the single tape 30 can perform desirable adhesion force.

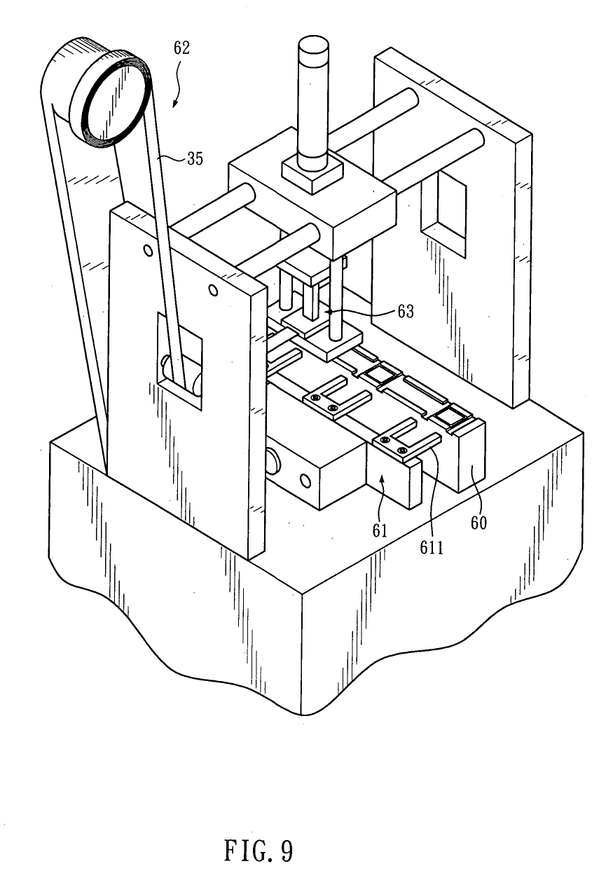

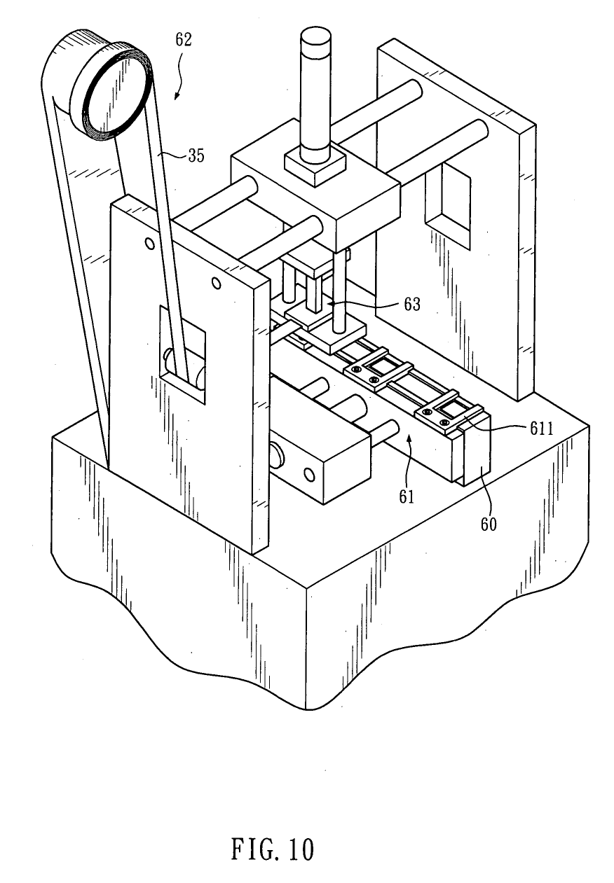

FIGS. 9 and 10 disclose an apparatus for practicing the foregoing process, wherein the apparatus comprises the following components.

A heating unit 60 is provided to heat the plastic carrier 20 to be combined with a single tape 30 to the predetermined temperature. According to the drawings, the heating unit 60 is a metal conveyor for carrying and conveying the plastic carriers 20.

A transporting unit 61 is provided to transporting the heated plastic carriers 20 to the predetermined position. According to the drawings, the transporting unit 61 is a plurality of clips 611 for clipping and moving the plastic carriers 20. Each of the clips 611 functions for moving one of the plastic carriers 20 to the predetermined position and for holding and positioning the plastic carrier 20 when the plastic carrier 20 is at the predetermined position and when the process of adhering the single tape 30 to the plastic carrier 20 is conducted.

A tape distributing unit 62 is provided to deliver the tape 35 in the form of a strip to pass over the plastic carriers 20 and cut the tape 35 into the rectangular single tape 30 at the position aligned to the plastic carrier 20 at the predetermined position.

A pressing unit 63 is provided to give the pressure to the upper surface of the single tape 30 so that the lower adhesive layer 31 at the lower surface of the single tape 30 is adhered to the plastic carrier 20.

Although a particular embodiment of the invention has been described in detail for purposes of illustration, it will be understood by one of ordinary skill in the art that numerous variations will be possible to the disclosed embodiments without going outside the scope of the invention as disclosed in the claims.

What is claimed is:

1. A process for heat-pressing a tape on a plastic carrier for a chip, comprising:
a) successively conveying a plurality of plastic carriers and positioning at least one of the plastic carriers at a predetermined position;
b) passing a tape in a form of a strip over the plastic carriers, wherein the tape comprises at least an adhesive at a surface facing the plastic carriers;
c) heating the plastic carriers to a temperature where the adhesive is melt to present preferable melted state and adhesion force;
d) cutting the tape at a position aligned to the plastic carrier at the predetermined position into a single tape; and
e) giving a downward pressure to a surface of the single tape reverse to the surface provided with the adhesive so that the single tape is separated from the tape and then the adhesive on the single tape comes into contact with the plastic carrier.

2. The process of claim 1, wherein the single tape in step d) is cut into a rectangular shape.

3. The process of claim 1, wherein the predetermined temperature is ranging from about 60 degrees centigrade to about 150 degrees centigrade.

4. The process of claim 1, wherein the step of heating the plastic carriers is conducted when the plastic carriers are conveying.

5. The process of claim 1, wherein the step of heating the plastic carriers is conducted when the plastic carriers arrive the predetermined position.

6. A process for heat-pressing a tape on a plastic carrier for a chip, primarily comprising:
heating the plastic carrier to a predetermined temperature in a process for adhering the tape to the plastic carrier, wherein the predetermined temperature is high enough to melt an adhesive on the single tape for adhering the plastic carrier to present preferable melted state and adhesion force;

7. The process of claim 6, wherein the predetermined temperature is ranging from about 60 degrees centigrade to about 150 degrees centigrade.
